(19) United States
(12) Patent Application Publication
(10) Pub. No.: US 2026/0274271 A1
(43) Pub. Date: Sep. 17, 2026

(54) METHOD TO DETERMINE VEHICLE MASS AND LONGITUDINAL ACCELERATION MEASUREMENT ERROR

(71) Applicants: FCA US LLC, Auburn Hills, MI (US); Stellantis Auto SAS, Poissy (FR)

(72) Inventor: Lubna S Khasawneh, Auburn Hills, MI (US)

(21) Appl. No.: 19/079,764

(22) Filed: Mar. 14, 2025

(51) Int. Cl. B60W 40/107; B60W 40/13; B60W 50/00; B60W 50/02

(52) U.S. Cl. CPC B60W 40/107; B60W 40/13; B60W 50/0097; B60W 50/0205; B60W 2050/0056; B60W 2050/0215; B60W 2510/0657; B60W 2520/105; B60W 2520/30; B60W 2530/10; B60W 2530/16; B60W 2552/15

(57) ABSTRACT

A method for estimating both vehicle mass and longitudinal acceleration in a vehicle based on a measured longitudinal acceleration from a sensor of the vehicle, includes obtaining a measured longitudinal acceleration from the sensor and a predetermined vehicle mass, providing a regression formula to determine a total force as a function of vehicle mass and vehicle acceleration, where the vehicle acceleration is the measured longitudinal acceleration modified by a sensor error, using a Kalman filter to solve the regression formula where vehicle mass is a first of two states and the sensor error is a second of the two states, and determining both the sensor error and the vehicle mass as a function of a Kalman filter gain and the total force. From this method both a real-time or instantaneous vehicle mass and an acceleration sensor bias or error can be determined.

### FIELD

The present disclosure relates to methods for determining an estimated vehicle mass and longitudinal acceleration sensor measurement error.

### BACKGROUND

Vehicle accelerations are measured by one or more sensors. Acceleration determinations are used in various vehicle control systems and schemes and accurate determinations can improve vehicle dynamics and control. Acceleration sensors can have a bias or offset, and can provide noisy output signals/data, whereby output from the sensor is different than the actual value of the parameter detected by the sensor. This sensor measurement error can affect performance of systems that utilize the senor outputs. Further, the mass of a vehicle changes over time due to changes in, for example, amount of fuel level in a fuel tank, number of occupants in the vehicle, cargo in or on the vehicle and whether the vehicle is towing a trailer.

### SUMMARY

In at least some implementations, a method for estimating both vehicle mass and longitudinal acceleration in a vehicle based on a measured longitudinal acceleration from a sensor of the vehicle, includes obtaining a measured longitudinal acceleration from the sensor and a predetermined vehicle mass, providing a regression formula to determine a total force as a function of vehicle mass and vehicle acceleration, where the vehicle acceleration is the measured longitudinal acceleration modified by a sensor error, using a Kalman filter to solve the regression formula where vehicle mass is a first of two states and the sensor error is a second of the two states, and determining both the sensor error and the vehicle mass as a function of a Kalman filter gain and the total force. From this method both a real-time or instantaneous vehicle mass and an acceleration sensor bias or error can be determined.

In at least some implementations, the total force is determined also as a function of a wheel size and a powertrain torque. In at least some implementations, the powertrain torque is a torque at the vehicle wheels determined as a function of an engine torque and a driveline ratio.

In at least some implementations, the total force includes a wheel force which is a longitudinal force from a wheel to a vehicle body, an aerodynamic force determined as a function of a surface area of part of the vehicle, a rolling resistance force and the force of gravity. In at least some implementations, the wheel force is a wheel torque divided by a wheel radius, and the wheel torque is determined as a function of the powertrain torque and a driveline ratio. In at least some implementations, the aerodynamic force is determined as a function of air density, a drag coefficient and the vehicle speed.

In at least some implementations, the rolling resistance is determined as a function of a rolling resistance coefficient and gravitational acceleration. In at least some implementations, the gravitational force is determined as a function of a road slope along which the vehicle is traveling.

In at least some implementations, the Kalman filter includes a predicted vehicle mass, a predicted acceleration, and a predicted error variance that is determined as a function of a process variance which is a tunable design parameter.

In at least some implementations, the method includes determining each of a first state vector for the first state, second state vector for the second state, a first error covariance for the first state, and a second error variance for the second state, and predicting each of a next first state vector, a next second state vector, a next first error covariance and a next second error covariance, determining a first residual covariance for the first state, and a second residual covariance for the second state, as a function of the measured longitudinal acceleration and the vehicle mass, and calculating a Kalman filter gain as a function of the first error covariance, the second error covariance, the first residual covariance and the second residual covariance.

In at least some implementations, a method of estimating vehicle mass and an error in a measured longitudinal acceleration from an accelerometer of a vehicle includes:
setting an initial state vector as

$$\hat{X} ( 0 ) = [ \begin{matrix}{\hat{x}}_{1} ( 0 ) \\ {\hat{x}}_{2} ( 0 )\end{matrix} ] = [ \begin{matrix}\hat{m} ( 0 ) \\ \hat{m} {\hat{a}}_{bias} ( 0 )\end{matrix} ] ;$$

where an initial value a first state \hat{m}(k) is a predetermined vehicle mass and an initial value of a second state \hat{m}â_{bias}(k) is zero;
initializing an error covariance matrix P as

$$P ( 0 ) = [ \begin{matrix}1 & 0 \\ 0 & 1\end{matrix} ] ;$$

predicting a next state vector as:

$$\hat{X} ( k ) = [ \begin{matrix}{\hat{x}}_{1} ( k ) \\ {\hat{x}}_{2} ( k )\end{matrix} ] = [ \begin{matrix}\hat{m} ( k ) \\ \hat{m} {\hat{a}}_{bias} ( k )\end{matrix} ] = {\underbrace{[ \begin{matrix}1 & 0 \\ 0 & 1\end{matrix} ]}}_{A} [ \begin{matrix}\hat{m} ( k - 1 ) \\ \hat{m} {\hat{a}}_{bias} ( k - 1 )\end{matrix} ] ;$$

predicting a next error covariance as Pₖ=APₖ₋₁A^{T}+Q; where

$$Q = [ \begin{matrix}{q}_{11} & 0 \\ 0 & {q}_{22}\end{matrix} ] ,$$

q₁₁ represents the variance of the first state \hat{m}(k), and q₂₂ represents the variance of the second state \hat{m}â_{bias}(k);
obtaining a measured longitudinal acceleration from the accelerometer;
determining C=[aₘₑₐₛ(k)−1], and determining a residual covariance as: S=CPₖ₋₁C^{T}+R; where R is a design matrix that represents a measurement variance;
determining a Kalman gain as: K=Pₖ₋₁C^{T}S⁻¹;
determine a total force F_{Total} as a function of a powertrain torque;
determining a residual error as:

$$ϵ = y - C \hat{X} ( k - 1 ) = {F}_{Total} ( k ) - C \hat{X} ( k - 1 ) , \\ where y = {F}_{Total} ( k ) and \hat{X} ( k - 1 ) = [ \begin{matrix}\hat{m} ( k - 1 ) \\ \hat{m} {\hat{a}}_{bias} ( k - 1 )\end{matrix} ]$$

is the estimated state vector;
determining an updated error covariance Pₖ and an updated state vector \hat{X}(k) as: Pₖ=(I−KC)Pₖ₋₁; where I is an identity 2×2 matrix, and \hat{X}(k)=\hat{X}(k−1)+Ke; and determining a corrected vehicle acceleration a_{actual} by modifying the measured acceleration by the determined sensor error as:

$${a}_{actual} = {a}_{meas} - \frac{\hat{m} {\hat{a}}_{bias} ( k )}{\hat{m} ( k )} .$$

In at least some implementations, the design matrix Q and the design matrix R are both tuned by starting with an identity matrix and then determining a response of an observer and tuning the design matrices as a function of the response.

In at least some implementations, the total force is determined as a function of a wheel force which is a wheel torque divided by a wheel radius, an aerodynamic force determined as a function of a surface area of part of the vehicle, a rolling resistance force determined as a function of a rolling resistance coefficient and gravitational acceleration, and a gravitational force that is determined as a function of a road slope along which the vehicle is traveling.

In at least some implementations, the powertrain torque, wheel radius, the aerodynamic force, and the rolling resistance force are inputs provided from external sources.

In at least some implementations, the Kalman filter gain is a 2×1 matrix obtained from a standard Kalman filter formulation.

In at least some implementations, the method of claim 11 wherein the Kalman filter is in the form of:

$$[ \begin{matrix}\hat{m} ( k ) \\ \hat{m} {\hat{a}}_{bias} ( k )\end{matrix} ] = [ \begin{matrix}\hat{m} ( k - 1 ) \\ \hat{m} {\hat{a}}_{bias} ( k - 1 )\end{matrix} ] + K [ {F}_{Total} ( k ) - [ \begin{matrix}{a}_{meas} ( k ) & - 1\end{matrix} ] [ \begin{matrix}\hat{m} ( k - 1 ) \\ \hat{m} {\hat{a}}_{bias} ( k - 1 )\end{matrix} ] ] ;$$

where \hat{m}(k) is an optimal estimate of m(k) and \hat{m}â_{bias}(k) is an optimal estimate of ma_{bias}(k); and K is a Kalman filter time varying gain matrix and is a diagonal 2×2 matrix.

In at least some implementations, the corrected vehicle acceleration and a determined vehicle mass are provided to a vehicle control system and then the method is repeated to determine a new corrected vehicle acceleration and a new determined vehicle mass.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 illustrates a vehicle with various components and systems diagrammatically shown;

FIG. 2 is a diagrammatic view of a control system of the vehicle;

FIG. 3 is a flowchart of a method for determining error in a measured longitudinal acceleration; and

FIG. 4 is a flowchart of a method for determining error in a measured acceleration.

### DETAILED DESCRIPTION

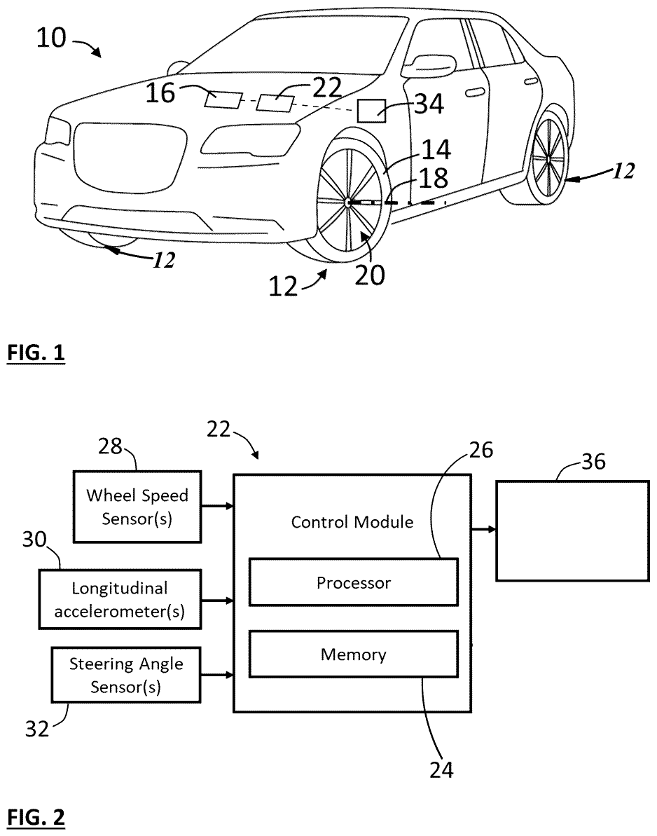

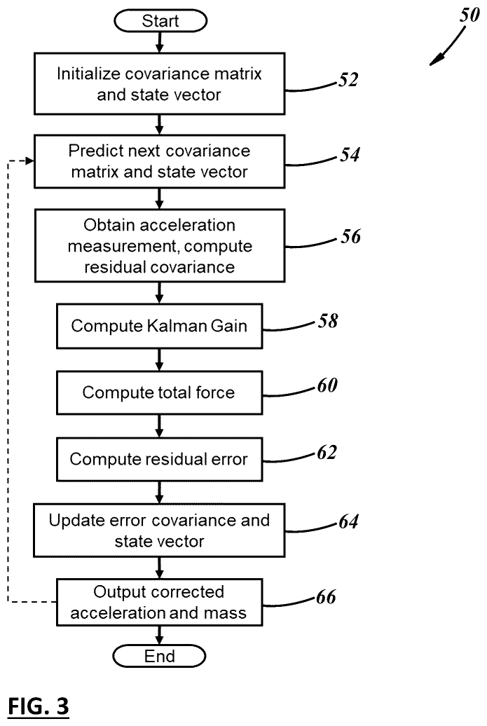

Referring in more detail to the drawings, FIG. 1 illustrates a vehicle 10 that includes multiple wheels 12 with tires 14, and a powertrain system 16 that may include one or both of an electric motor and a combustion engine, and may also include a transmission, via which torque is provided to the wheels 12 to rotate the wheels about axes of rotation 18 and propel the vehicle. The vehicle 10 may also include one or more brakes or brake assemblies 20 to decelerate the vehicle 10 and hold the vehicle stopped. Vehicle speed and acceleration may be determined by one or more wheel speed sensors 28 (FIG. 2) and one or more accelerometers 30. Additionally, steering angle may be determined by one or more steering angle sensors 32. These sensors, among other things, may be communicatively coupled with a controller 22 or control system (e.g., an engine control module). The controller 22 and sensors 28, 30, 32 may be used in control of one or move vehicle functions or systems, like autonomous or partially autonomous vehicle operation, anti-lock brake control, vehicle stability control, traction control, and the like. The controller 22 may include a memory 24 for storing data from the one or more sensors, and instructions or programs, and a processor 26 for processing the data and executing the instructions or programs stored in the memory.

In order to perform the functions and desired processing set forth herein, as well as the computations therefore, the controller 22 may include, but not be limited to, a processor(s), computer(s), DSP(s), memory, storage, register(s), timing, interrupt(s), communication interface(s), and input/output signal interfaces, and the like, as well as combinations comprising at least one of the foregoing. For example, controller 22 may include input signal processing and filtering to enable accurate sampling and conversion or acquisitions of such signals from communications interfaces and sensors. As used herein the terms controller 22 may refer to one or more processing circuits such as an application specific integrated circuit (ASIC), an electronic circuit, a processor (shared, dedicated, or group) and memory that executes one or more software or firmware programs, a combinational logic circuit, and/or other suitable components that provide the described functionality.

The term “memory” 24 or “storage” as used herein can include computer readable memory, and may be volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory 24 can store an operating system and/or instructions/programs executable by a processor or controller or the like to enable control or allocate resources of a computing device.

As shown in FIG. 2, to permit measurement of the rotational speed of the wheels 12, the wheel speed sensor 28 may be associated with one of the wheels 12 to provide an output to the controller 22 that is indicative of the rotation of the wheel. By way of a non-limiting example, the wheel speed sensor 28 may be a hall effect sensor with a magnet being rotated with the wheel or spindle and with a sensing element used to detect the magnet as it rotates by the sensing element. Of course, other types of rotational speed sensors may be used.

Additionally, acceleration may be measured using one or more accelerometers 30 which measures gravitational forces (i.e., g-forces) in a longitudinal (e.g. forward-rearward) direction, a lateral (e.g. cross-car) direction, and vertical (e.g. up/down) direction, as well as rotations about longitudinal, lateral and vertical axes. In at least one embodiment, the one or more accelerometers are defined by an Inertial Measurement Unit (IMU) that is a multi-axis accelerometer which provides simultaneous measurement of acceleration in three perpendicular axes and rotational velocities about the axes, for example.

To measure the position of wheels, the steering angle sensor 32 may be associated with one or more of the wheels 12 or with a steering shaft 34 of the vehicle 10. In at least one embodiment, the steering angle sensor may be a giant magnetoresistance (GMR) device, by way of one non-limiting example, that provides an absolute steering angle value over the complete steering angle range. Other types of sensors may be used, for example but not limited to, tunnel magnetoresistance (TMR) sensors and anisotropic magnetoresistance (AMR) sensors. The steering angle sensor 32 may provide an output that permits steering angle and/or steering angle velocity or rate of change of steering angle to be determined at the controller 22.

One or more systems 36 (FIGS. 2 and 3) of vehicle 10 may rely on the vehicle acceleration, wheel speed and/or steering angle data from the accelerometer 30 and/or steering angle sensor 32 during operation or during travel of the vehicle 10. Some systems may be on-board the vehicle 10 and some systems may be remote from the vehicle 10. For instance, an anti-lock braking system (ABS), traction control system (TC), electronic stability control system (ESC), on-board diagnostic monitors (OBD), torque security features, cruise control (CC), adaptive cruise control (ACC), acceleration control, and/or autonomous vehicle systems (AVS) may utilize some or all of the data from the accelerometer 30, wheel speed sensors, and/or steering angle sensor 32.

Sensors can have a bias or offset, and can provide noisy output signals/data, whereby output from the sensor is different than the actual value of the parameter detected by the sensor. For example, accelerometers 30 may output data regarding acceleration that is higher than the actual vehicle acceleration, and may, for example, output data indicating some acceleration when the vehicle is not accelerating. This bias or offset can affect performance of systems that utilize the senor outputs, and so it is desirable to determine and remove the sensor bias/offset before using the sensor outputs. For example, the sensor data may be used in feedback or feedforward control schemes and incorrect data can lead to poor or inaccurate control behavior.

While some sensors, including some IMUs 30, can have high levels of precision and low noise, these sensors are expensive, may require pre-calibration and are generally not used in mass production vehicles due to the cost of the sensors. Lower cost IMUs 30, on the other hand, are not well-calibrated and usually their measurements have a relatively high level of noise and bias. Before using low cost IMUs in production vehicles, their output measurements must be processed to account for/remove the noise and the bias. Noise can be handled by various filters, but the bias is more challenging to accurately and quickly determine and remove.

As noted above, sensors including accelerometers 30 often output a nonzero value when they are stationary and should therefore have an output of zero. This value is called static offset. Static offset is predictable, but a different type of offset, called dynamic offset, can vary with temperature, supply voltage, orientation of the sensor, asymmetrical loading of the vehicle and changes in vehicle mass. Dynamic offset cannot be easily predicted.

Further, one or more systems (shown by 36 in FIG. 2) of vehicle 10 may need the vehicle mass as an input, such as lateral control, longitudinal control, suspension control, and many vehicle state observers, such as lateral velocity and side slip angle. Those algorithms are usually calibrated based on a constant value of the vehicle mass, such as may be provided by the manufacturer and may be the weight of the empty vehicle in a laboratory or manufacturing facility, or some assumed average weight in use. But in reality, vehicle mass is not constant and changes depending on the number of passengers, the fullness of the gas tank, cargo loading and unloading, and the like. Further, if the vehicle is towing a trailer, its mass will significantly change. Thus, the vehicle mass changes, but the vehicle functions and systems are still using the constant value for mass, which is the wrong value in at least some conditions. Also, when the vehicle mass changes from the constant value that was provided, the performance of the vehicle systems will deteriorate because they were calibrated based on the initial constant value.

In at least some implementations, a method/algorithm determines or estimates both the vehicle mass and the dynamic offset of an accelerometer using, among other things, a Kalman filter and the static offset of the sensor is included in the estimation. Kalman filtering (sometimes also known as linear quadratic estimation) is an algorithm that uses a series of measurements observed over time, including statistical noise and other inaccuracies, to produce estimates of unknown variables, rather than estimating based on a single measurement. The Kalman filter can estimate a joint probability distribution over the variables for each time-step, and may be constructed as a mean squared error minimizer.

In general, the Kalman filter works via a two-phase process: a prediction phase and an update phase. In the prediction phase, the Kalman filter produces estimates of the current state variables, including their uncertainties. Once the outcome of the next measurement (necessarily including some error, including noise, bias and sensor offset(s)) is observed, these estimates are updated using a weighted average, with more weight given to estimates with greater certainty. The algorithm is recursive. It can operate in real time, using only the present input measurements and the state calculated previously and its uncertainty matrix; no additional past information is required.

The governing equation of vehicle longitudinal dynamics can be approached according to Newton second law of motion, which is given by:

$$ma = {F}_{Total} ⇒ a = \frac{{F}_{Total}}{m} ,$$

where, Fₜₒₜₐₗ=Fₓ−Fₐ−F_{R}−F_{g}. Here Fₜₒₜₐₗ is the net longitudinal forces acting on the vehicle. Fₓ is the force acting on the vehicle tires generated via road-tire interaction, which depends on the torque T_{W} acting on the wheels and the wheel radius R_{W}. τ_{W} might be obtained directly from another vehicle system or sensor, e.g. available via a CAN bus of the vehicle. If the torque τ_{W} is not available, it can be computed from engine torque (as a function of a driveline ratio, e.g. a gear ratio for gears between a prime mover and the vehicle wheels) and brake torque, as follows:

$${F}_{x} = \frac{{τ}_{w * driveline ratio}}{{R}_{W}} .$$

Next, Fₐ is the aerodynamic force, F_{R} is the rolling resistance force, and F_{g} is the gravity force. The forces Fₐ, F_{R}, and F_{g} may be computed from separate algorithms in known manner. Further, m is the vehicle mass, and a is the vehicle acceleration.

The actual acceleration of the vehicle can be written as:

$$\frac{{F}_{Total}}{m} = {a}_{meas} - {a}_{bias} ,$$

which a_{actual}=aₘₑₐₛ−a_{bias}; and by substitution, becomes: Fₜₒₜₐₗ=maₘₑₐₛ−ma_{bias}. And this equation can be written as:

$${F}_{Total} = [ \begin{matrix}{a}_{meas} & - 1\end{matrix} ] [ \begin{matrix}m \\ {ma}_{bias}\end{matrix} ]$$

A Kalman filter can be formulated to solve the above problem as below:

$$[ \begin{matrix}m ( k ) \\ {ma}_{bias} ( k )\end{matrix} ] = [ \begin{matrix}1 & 0 \\ 0 & 1\end{matrix} ] [ \begin{matrix}m ( k - 1 ) \\ {ma}_{bias} ( k - 1 )\end{matrix} ] + [ \begin{matrix}{w}_{1} ( k ) \\ {w}_{2} ( k )\end{matrix} ] .$$

Here, mass and the longitudinal sensor bias are treated as the states of the system. The first state is \hat{m}(k), and the second state is ma_{bias}(k). Because the second state is mass multiplied by bias, it needs to be divided by mass to obtain a pure value of the bias. Further, w₁ is the process noise associated with the first state m, and w₂ is the process noise associated with the second state ma_{bias}. From this, the measurement equation can be represented as:

$${F}_{Total} ( k ) = [ \begin{matrix}{a}_{meas} ( k ) & - 1\end{matrix} ] [ \begin{matrix}m ( k - 1 ) \\ {ma}_{bias} ( k - 1 )\end{matrix} ] + n ( k ) ;$$

where n (k) is the measurement noise associated with the measured force and longitudinal acceleration.

Based on the above system and measurement models, the Kalman filter takes the form:

$$[ \begin{matrix}\hat{m} ( k ) \\ \hat{m} {\hat{a}}_{bias} ( k )\end{matrix} ] = [ \begin{matrix}\hat{m} ( k - 1 ) \\ \hat{m} {\hat{a}}_{bias} ( k - 1 )\end{matrix} ] + K [ {F}_{Total} ( k ) - [ \begin{matrix}{a}_{meas} ( k ) & - 1\end{matrix} ] [ \begin{matrix}\hat{m} ( k - 1 ) \\ \hat{m} {\hat{a}}_{bias} ( k - 1 )\end{matrix} ] ] ;$$

where \hat{m}(k) denotes the optimal estimate of \hat{m}(k) and \hat{m}â_{bias}(k) denotes the optimal estimate of ma_{bias}(k). K is the Kalman filter time varying gain matrix obtained from the standard Kalman filter formulation, which is a diagonal 2×2 matrix in this example.

The Kalman filter observer formulation can be done in several steps as in the example set forth herein, and with reference to the diagram of FIG. 3 which illustrates a method 50 of determining vehicle mass and a vehicle acceleration as a function of a measured acceleration and an estimated error in the measured acceleration. First, in step 52, the optimal state vector is initialized:

$$\hat{X} ( 0 ) = [ \begin{matrix}{\hat{x}}_{1} & ( 0 ) \\ {\hat{x}}_{2} & ( 0 )\end{matrix} ] = [ \begin{matrix}\hat{m} ( 0 ) \\ \hat{m} {\hat{a}}_{bias} ( 0 )\end{matrix} ]$$

and the error covariance matrix P is initialized. Initializing the state vector can be random and can be set to zero. In this example, the initial value of \hat{m}(k) was set to the initially known or predetermined value of the mass, such as may be obtained from weighing the empty vehicle in a vehicle dynamics laboratory or after manufacturing the vehicle, and the initial value of ma_{bias}(k) was set to zero. The error covariance matrix P is usually initialized to the identity matrix, which is a 2×2 matrix in this algorithm,

$$P ( 0 ) = [ \begin{matrix}1 & 0 \\ 0 & 1\end{matrix} ] .$$

Next, in step 54, the next state vector and covariance matrix are predicted:

$$\hat{X} ( k ) = [ \begin{matrix}{\hat{x}}_{1} & ( k ) \\ {\hat{x}}_{2} & ( k )\end{matrix} ] = [ \begin{matrix}\hat{m} ( k ) \\ \hat{m} {\hat{a}}_{bias} ( k )\end{matrix} ] = \underbrace{\begin{matrix}[ \begin{matrix}1 & 0 \\ 0 & 1\end{matrix} ] & \end{matrix}}_{A} [ \begin{matrix}\hat{m} ( k - 1 ) \\ \hat{m} {\hat{a}}_{bias} ( k - 1 )\end{matrix} ] ;$$

and Pₖ=APₖ₋₁A^{T}+Q, where

$$Q = [ \begin{matrix}{q}_{11} & 0 \\ 0 & {q}_{22}\end{matrix} ]$$

is a design matrix that represents the process covariance, which can be a diagonal matrix, q₁₁ represents the variance of the first state \hat{m}(k), and q₂₂ represents the variance of the second state \hat{m}â_{bias}(k).

In step 56, a longitudinal acceleration measurement from the IMU (e.g. from the CAN bus). Computations are done for the measurement vector C=[aₘₑₐₛ(k)−1], and then residual covariance: S=CPₖ₋₁C^{T}+R, where R is a design matrix that represents the measurement covariance, which can be and is scalar in this algorithm.

In step 58, the Kalman gain is computed: K=Pₖ₋₁C^{T}S⁻¹. In step 60, the wheel radius and wheel torque are obtained as inputs, then wheel force Fₓ is computed:

$${F}_{x} = \frac{{τ}_{w * drivelineratio}}{{R}_{W}} .$$

Next, the rest of the forces are obtained (e.g. computed externally and/or provided as inputs), then the total net force is computed, and in step 62 measurement residual error is computed: F_{Total}=Fₓ−Fₐ−F_{R}−F_{g}; and ε=y−C\hat{X}(k−1)=Fₜₒₜₐₗ(k)−C\hat{X}(k−1), where y=F_{Total}(k) and

$$\hat{X} ( k - 1 ) = [ \begin{matrix}\hat{m} ( k - 1 ) \\ \hat{m} {\hat{a}}_{bias} ( k - 1 )\end{matrix} ]$$

is the estimated state vector.

In step 64, the error covariance Pₖ and estimated vector \hat{X}(k) are updated:
Pₖ=(I−KC)Pₖ₋₁; where I is the identity 2×2 matrix; and

$$\hat{X} ( k ) = \hat{X} ( k - 1 ) + Kϵ .$$

In step 66, \hat{m}â_{bias}(k) is divided by \hat{m}(k) to obtain the sensor bias and correct the longitudinal acceleration signal by subtracting the estimated bias:

$$\begin{matrix}{a}_{actual} = {a}_{meas} - {a}_{bias} \\ = {a}_{meas} - \frac{\hat{m} {\hat{a}}_{bias} ( k )}{\hat{m} ( k )} \\ \end{matrix} .$$

Then, the corrected estimate of both acceleration and mass may be provided to the vehicle functions or systems that use acceleration and mass values, and the method may return to and repeat from step 54, using the just determined acceleration and mass values as the basis for predictions of the next covariance matrix and next state vector.

In at least some implementations, the choice of the Q and R design matrices can significantly affect the results of the state observer. They are usually tuned by trial and error, and in the method described this may be started by the identity matrices and the response of the observer watched to enable calibration until a satisfactory response is met.

Thus, the longitudinal acceleration can be estimated by the method noted above which utilizes engine torque as an input instead of wheel speed. Wheel speed can be unreliable as the wheels may move (e.g. slip or slide) on and relative to the ground such as, by way of non-limiting examples, during rapid acceleration or hard braking events. During, for example, wheel loss of traction events, the acceleration estimation if based on wheel speed inputs, cannot be relied upon. The engine torque data, however, is more reliable and is not thrown off by loss of traction at the wheels as is the wheel speed, and thus enables more accurate longitudinal acceleration estimation in a wide range of circumstances. Thus, the longitudinal acceleration sensor bias/offset/noise can be reliably estimated and an accurate estimation of the actual, instantaneous longitudinal acceleration can be determined and then provided to various vehicle systems and controllers that rely upon longitudinal acceleration information.

Additionally, the mass of a vehicle can change significantly over time. For example, more or fewer passengers may be in the vehicle, more or less fuel and cargo, and the vehicle may pull a trailer some of the time. All of these things can occur together or individually. Further, the mass of the vehicle may change in use, for example, as fuel is consumed. While mass may be considered to be a slowly varying parameter within a single use, the mass may continually change, and the algorithms and methods taught herein enable updating and improvements to the mass determination of the vehicle. The improved mass determination also enables improvement in determining the longitudinal acceleration measurement error to enable improved estimation of actual vehicle acceleration. With the mass being updated and redetermined in subsequent iterations of the method/algorithms, the subsequent longitudinal acceleration determinations are always made in view of an updated mass determination for improved accuracy.

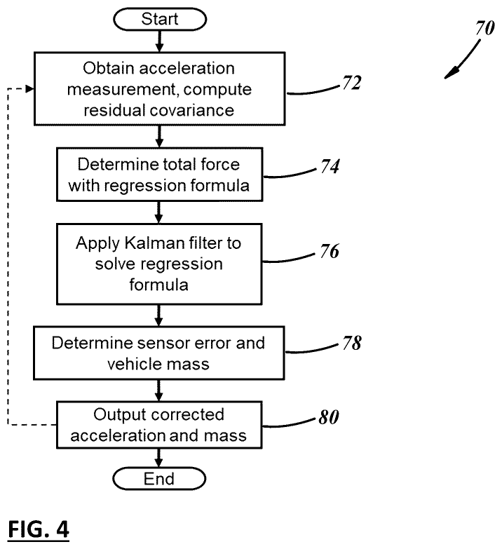

In the method 70 shown in FIG. 4 and with regard to the algorithm and method 50 described above, powertrain torque, wheel size, aerodynamic force, rolling resistance force, gravitational force, a driveline ratio (shown as input 61 in FIG. 3) and the output from the accelerometer are used as inputs to the algorithm of the method. The algorithm permits determination of instantaneous offset and bias of the accelerometer and adjustment of the measured acceleration to a more accurate, estimated acceleration that is better used in vehicle systems. The algorithm also determines a real-time vehicle mass so that changes in the vehicle mass can be accounted for in various vehicle control systems, and can be used in determining the corrected vehicle acceleration to improve the accuracy of the correction made.

In the method 70 of FIG. 4, step 72 includes obtaining a measured acceleration from an accelerometer 30 and a nominal, predetermined vehicle mass. The method then determines an error in the measured acceleration which includes a bias and a dynamic offset, as noted herein. And the method determines an instantaneous vehicle mass. In step 74, a regression formula is used to determine a total force as a function of vehicle mass and vehicle acceleration. In step 76, a Kalman filter is used to solve the regression formula, where vehicle mass is a first of two states and the sensor error is a second of the two states. And in step 78 both the sensor error and the vehicle mass are determined as a function of a Kalman filter gain and the total force. Finally, in step 80 a corrected, estimated longitudinal acceleration and the determined, instantaneous vehicle mass is provided to other vehicle systems and algorithms to enable desired control of the vehicle.

To estimate both vehicle mass and acceleration, the method may include determining a first state vector for the first state (e.g. mass), a second state vector for the second state (e.g. acceleration bias/error), a first error covariance for the first state and a second error variance for the second state. The method may also include predicting a next first state vector, a next second state vector, a next first error covariance and a next second error covariance, determining a first residual covariance for the first state, and a second residual covariance for the second state, as a function of the measured longitudinal acceleration and the vehicle mass. And then calculating a Kalman filter gain as a function of the first error covariance, the second error covariance, the first residual covariance and the second residual covariance.

What is claimed is:

1. A method for estimating both vehicle mass and longitudinal acceleration in a vehicle based on a measured longitudinal acceleration from a sensor of the vehicle, comprising:
obtaining a measured longitudinal acceleration from the sensor and a predetermined vehicle mass;
providing a regression formula to determine a total force as a function of vehicle mass and vehicle acceleration, where the vehicle acceleration is the measured longitudinal acceleration modified by a sensor error;
using a Kalman filter to solve the regression formula where vehicle mass is a first of two states and the sensor error is a second of the two states; and
determining both the sensor error and the vehicle mass as a function of a Kalman filter gain and the total force.

2. The method of claim 1 wherein the total force is determined also as a function of a wheel size and a powertrain torque.

3. The method of claim 2 wherein the powertrain torque is a torque at the vehicle wheels determined as a function of an engine torque and a driveline ratio.

4. The method of claim 1 wherein the total force includes a wheel force which is a longitudinal force from a wheel to a vehicle body, an aerodynamic force determined as a function of a surface area of part of the vehicle, a rolling resistance force and the force of gravity.

5. The method of claim 4 wherein the wheel force is a wheel torque divided by a wheel radius, and the wheel torque is determined as a function of the powertrain torque and a driveline ratio.

6. The method of claim 4 wherein the aerodynamic force is determined as a function of air density, a drag coefficient and the vehicle speed.

7. The method of claim 4 wherein the rolling resistance is determined as a function of a rolling resistance coefficient and gravitational acceleration.

8. The method of claim 4 wherein the gravitational force is determined as a function of a road slope along which the vehicle is traveling.

9. The method of claim 1 wherein the Kalman filter includes a predicted vehicle mass, a predicted acceleration, and a predicted error variance that is determined as a function of a process variance which is a tunable design parameter.

10. The method of claim 1 which includes:
determining a first state vector for the first state, a second state vector for the second state, a first error covariance for the first state and a second error variance for the second state;
predicting a next first state vector, a next second state vector, a next first error covariance and a next second error covariance;
determining a first residual covariance for the first state, and a second residual covariance for the second state, as a function of the measured longitudinal acceleration and the vehicle mass; and
calculating a Kalman filter gain as a function of the first error covariance, the second error covariance, the first residual covariance and the second residual covariance.

11. A method of estimating vehicle mass and an error in a measured longitudinal acceleration from an accelerometer of a vehicle, comprising:
setting an initial state vector as
$$\hat{X} ( 0 ) = [ \begin{matrix}{\hat{x}}_{1} & ( 0 ) \\ {\hat{x}}_{2} & ( 0 )\end{matrix} ] = [ \begin{matrix}\hat{m} ( 0 ) \\ \hat{m} {\hat{a}}_{bias} ( 0 )\end{matrix} ] ;$$
where an initial value a first state \hat{m}(k) is a predetermined vehicle mass and an initial value of a second state \hat{m}â_{bias}(k) is zero;
initializing an error covariance matrix P as
$$P ( 0 ) = [ \begin{matrix}1 & 0 \\ 0 & 1\end{matrix} ] ;$$
predicting a next state vector as:
$$\hat{X} ( k ) = [ \begin{matrix}{\hat{x}}_{1} & ( k ) \\ {\hat{x}}_{2} & ( k )\end{matrix} ] = [ \begin{matrix}\hat{m} ( k ) \\ \hat{m} {\hat{a}}_{bias} ( k )\end{matrix} ] = \underbrace{\begin{matrix}[ \begin{matrix}1 & 0 \\ 0 & 1\end{matrix} ] & \end{matrix}}_{A} [ \begin{matrix}\hat{m} ( k - 1 ) \\ \hat{m} {\hat{a}}_{bias} ( k - 1 )\end{matrix} ] ;$$
predicting a next error covariance as Pₖ=APₖ₋₁A^{T}+Q; where
$$Q = [ \begin{matrix}{q}_{11} & 0 \\ 0 & {q}_{22}\end{matrix} ] ,$$
q₁₁ represents the variance of the first state \hat{m}(k), and q₂₂ represents the variance of the second state \hat{m}â_{bias}(k);
obtaining a measured longitudinal acceleration from the accelerometer;
determining C=[aₘₑₐₛ(k)−1], and determining a residual covariance as: S=CP k−1C^{T}+R; where R is a design matrix that represents a measurement variance;
determining a Kalman gain as: K=Pₖ₋₁C^{T}S⁻¹;
determine a total force Fₜₒₜₐₗ as a function of a powertrain torque;
determining a residual error as:
$$ϵ = y - C \hat{X} ( k - 1 ) = {F}_{total} ( k ) - C \hat{X} ( k - 1 ) , where y = {F}_{Total} ( k ) and \hat{X} ( k - 1 ) = [ \begin{matrix}\hat{m} ( k - 1 ) \\ \hat{m} {\hat{a}}_{bias} ( k - 1 )\end{matrix} ]$$
is the estimated state vector;
determining an updated error covariance Pₖ and an updated state vector X(k) as: Pₖ=(I−KC)Pₖ₋₁; where I is an identity 2×2 matrix, and X(k)= (k−1)+Ke; and
determining a corrected vehicle acceleration a_{actual} by modifying the measured acceleration by the determined sensor error as:
$${a}_{actual} - {a}_{meas} - \frac{\hat{m} {\hat{a}}_{bias} ( k )}{\hat{m} ( k )} .$$

12. The method of claim 11 wherein the design matrix Q and the design matrix R are both tuned by starting with an identity matrix and then determining a response of an observer and tuning the design matrices as a function of the response.

13. The method of claim 11 wherein the total force is determined as a function of a wheel force which is a wheel torque divided by a wheel radius, an aerodynamic force determined as a function of a surface area of part of the vehicle, a rolling resistance force determined as a function of a rolling resistance coefficient and gravitational acceleration, and a gravitational force that is determined as a function of a road slope along which the vehicle is traveling.

14. The method of claim 13 wherein the wheel torque is determined as a function of the powertrain torque and a driveline ratio.

15. The method of claim 13 wherein the aerodynamic force is determined as a function of air density, a drag coefficient and the vehicle speed.

16. The method of claim 13 wherein the powertrain torque, wheel radius, the aerodynamic force, and the rolling resistance force are inputs provided from external sources.

17. The method of claim 11 wherein the Kalman filter gain is a 2×1 matrix obtained from a standard Kalman filter formulation.

18. The method of claim 11 wherein the Kalman filter is in the form of:
$$[ \begin{matrix}\hat{m} ( k ) \\ \hat{m} {\hat{a}}_{bias} ( k )\end{matrix} ] = [ \begin{matrix}\hat{m} ( k - 1 ) \\ \hat{m} {\hat{a}}_{bias} ( k - 1 )\end{matrix} ] + \\ K [ {F}_{Total} ( k ) - [ {a}_{meas} ( k ) - 1 ] [ \begin{matrix}\hat{m} ( k - 1 ) \\ \hat{m} {\hat{a}}_{bias} ( k - 1 )\end{matrix} ] ] ;$$
where \hat{m}(k) is an optimal estimate of \hat{m}(k) and \hat{m}â_{bias}(k) is an optimal estimate of ma_{bias}(k); and K is a Kalman filter time varying gain matrix and is a diagonal 2×2 matrix.

19. The method of claim 11 wherein the corrected vehicle acceleration and a determined vehicle mass are provided to a vehicle control system and then the method is repeated to determine a new corrected vehicle acceleration and a new determined vehicle mass.
